(19) United States
(12) Patent Application Publication
(10) Pub. No.: US 2012/0266078 A1
(43) Pub. Date: Oct. 18, 2012

(54) System and Method for Accessing and Displaying Remotely Backed Up Data by Deploying a Windows Desktop Style User Interface

(75) Inventor: Raghavendra Kulkarni, West Hills, CA (US)

(73) Assignee: PROSOFTNET CORPORATION, Calabasas, CA (US)

(21) Appl. No.: 13/088,707

(22) Filed: Apr. 18, 2011

(51) Int. Cl. G06F 3/01; G06F 15/16

(52) U.S. Cl. 715/740

(57) ABSTRACT

A system and method for accessing and displaying remotely backup data by deploying Windows desktop style User Interface. Upon invoking the application program installed on a local computer, the remotely backed up data can be accessed from the application User Interface after establishing a connection with the remote backup server via a network. The application program running on the local computer displays remotely stored data through a User Interface identical to the desktop of the windows operating system running on the local computer from where backup was taken. More specifically, the data is stored under the same folder names and same folder hierarchy including the icon names and positions of the icons, taskbar and start button on the windows desktop of the local computer. The user is easily able to visually recognize the same file system from the remote backup sever as is available on the local computer.

### TECHNICAL FIELD OF THE INVENTION

The invention relates to a system and method for accessing and displaying remotely backed up data backed up data in windows desktop style User Interface.

### BACKGROUND OF THE INVENTION

Computer technology is continuously advancing, resulting in modern computer systems with ever increasing performance. One result of this increased performance is an increased use of computer systems by people in a wide variety of business, academic and personal avocations. Since a couple of years, computer users are becoming increasingly conscience to the importance of data protection in general and data backup in specific. Storage systems provide a critical part of an organization's network infrastructure. With the amount of data growing at an incredible rate, the storage strategy must keep pace. Losing important data may lead to serious disaster to a business as well to an individual.

For many corporate enterprises, essentially a large percentage of corporate data resides on computer network in remote locations or on distributed resources, such as desktops and laptops, which are rarely backed up. Storage administrators in centralized locations may not even be aware of the poor state of data protection in these remote locations or may not know how to address this issue cost-effectively. In the event of outages, organizations with unprotected critical data run the risk of application downtime, lost data, security breaches, or failure to comply with regulations at these remote sites.

A number of service providers offer services related to online backup-and-recovery service that include secure backup and recovery over the internet for off-site data protection for remote desktops, laptops, and branch-office servers in small to large distributed enterprise environments. All these available service providers provide a secure, reliable and predictable data protection cloud backup model.

Generally, known remote storage systems provide one or the other kind of User Interface for online backup which are not user friendly that sometimes becomes frustrating to any ordinary user during critical period. In such a situation, the user becomes more prone to committing mistakes while uploading or accessing important data. Hence, users are forced to seek assistance from a system administrator or to call the ‘Help Desk’ in the organization's technical department. This procedure is generally inefficient and can frequently be chaotic and frustrating to the users.

Hence what is needed is a system and method that provides an intuitive and user friendly User Interface through which a user can access and display remotely backed up data.

### SUMMARY OF THE INVENTION

To overcome the limitations in the prior art described above, preferred embodiments disclose a system and method for accessing and displaying remotely backed up data by deploying a Windows desktop style User Interface

In preferred embodiments, an application program is installed on a local computer. Upon invoking the application program from the local computer, a User Interface is presented that prompts the user to enter unique login information such as username and password provided for each user. After entering username/email ID and password, the system establishes a connection with the remote backup server via a network. In further embodiments, after an authorized user successfully logs into the application program, the application program running on the local computer displays remotely stored data through a User Interface identical to the desktop of the windows operating system running on the local computer from where backup was taken, thereby allowing a user to easily identify and access the data stored under various locations in remote backup server. The remote backup server keeps a backup of all the data from the local computer in the same manner as is stored in windows operating system. More specifically, the data is stored under the same folder names and same folder hierarchy including the icon names and positions of the icons on the windows desktop of the local computer. Since the User Interface of the application program is similar to the User Interface provided by the Windows Operating system, the user is easily able to visually recognize the same file system from the remote sever as is available on the local computer.

In another embodiment of the invention, a major portion the application User Interface window displays a plurality of elements such as files/folders icons which are arranged in the same manner as are arranged in the local computer from where the backup was taken. The icons in the form of file/folders represent a shortcut to the data stored under various locations and under the same filename as stored in the remote backup server. When a user right clicks the mouse button on one of the folder icons on the application User Interface, a folder context menu is displayed next to the file/folder which allows a user to select an action out of various options provided in context of a folder that may include actions such as open, copy, explore, restore etc. whereby a folder can be opened, copied, explored through windows browser or restored to its original location on the local computer from where it was uploaded during backup. The icons on the application User Interface provide a user with a clear and integral indication of the data stored in the remote backup server. Similarly, when a user right clicks the mouse button on one of the file icons on the application User Interface, a file context menu is displayed next to the file which allows a user to select an action out of various options provided in context of a file that may include operations such as open, copy, restore, version etc. whereby a file can be opened, copied, restored to its original location on the local computer or its version information can be viewed by the user. The context menu provides options for easy and seamless management of data on the remote backup server. The user interacts with the User Interface presented by the system and facilitates intuitive and user friendly management of remote storage data in a manner similar to a local storage volume.

In still another embodiment of the invention, a consistently visible taskbar is provided on the bottommost portion of the application User Interface that further comprises a plurality of user detectable button to initiate a variety of operations. Just like Windows operating system, a user merely need to single click on the button in order to switch to an active task.

In yet another embodiment of the invention, the left most portion of the taskbar further comprises a ‘Start’ button that serves as a centralized location for accessing data stored under various locations on remote backup server. Upon left mouse click on the ‘Start’ button, a popup menu, with options such as ‘My Computer’, ‘My Documents’, ‘Search’, ‘Exit’ is displayed in the same manner as in a local computer running Windows Operating System. The rightmost portion of the taskbar includes a clock which displays a digital clock.

In one more embodiment, upload or download of data between remote backup server and local computer can be performed by easy drag and drop operation through application User Interface whereby a user can easily exchange data between local computer and remote backup server.

In still another more embodiment, user settings for the User Interface can also be maintained by the remote backup server. When a user logs into the application program after authentication, the last saved user settings are generated and displayed on the application User Interface. Each time a user terminates the application program session; last saved user settings are automatically saved and again generated and applied next time the user log into the application program and the desktop icons are automatically placed in the same position as were arranged before termination of the previous session. In this way, the user automatically returns to the exact desktop environment in the state at the time of the prior access.

In yet another embodiment of the invention, the User Interface displayed under a particular login name is identical to the User Interface of the local computer from where backed up under the same login name.

In one more embodiment, a method for accessing remote backed up data by deploying a Windows desktop style User Interface is described wherein the user invokes the installed application program by double clicking the program icon on the program menu or shortcut on the desktop of the windows operating system running on the local computer. An application User Interface is displayed that prompts the user to enter his unique login information such as username and password. The application program establishes a connection with remote backup server after the user enters the login information prompted by the application program. The remote backup server performs user authentication based on the login information. Upon authentication, the method provides access to remote backup server and displays the backed up data in Windows desktop style User Interface which is identical to the User Interface of the windows desktop of the local computer from where the backup was taken under the same login information.

Using the User Interface as represented by application User Interface, a user can perform many common file management operations including uploading, downloading, and other related functions in a manner similar to windows operating system. The User Interface provided by the system displays remotely stored data in a user friendly and familiar manner and provides a seamless access to remote storage server. The Window desktop style User Interface allows a user to intuitively access the file monitoring application features.

### ADVANTAGES

One of the main advantages of the invented system is that a user doesn't require any formal training or assistance while performing functions related to accessing, uploading or downloading data from remote backup server since the environment provided by the system is quite similar to basic Windows desktop style User Interface which a user is accustomed to viewing. The User Interface provided by the system is user friendly as compared to any other existing backup applications. The invention provides simple functionalities that facilitate easy restoration, uploading and downloading of the data between local computer and remote backup server. The drag and drop operations further ease the basic functionalities associated with the file management. The system provides options to open and minimize multiple task windows that can be docked on the taskbar.

### BRIEF DESCRIPTION OF THE DRAWINGS

The details of one or more embodiments of the invention are set forth in the accompanying drawings and the description below. Other features, objects and advantages of the invention will be apparent from the description, drawings and claims.

FIG. 1 illustrates an exemplary hardware and operating environment of a suitable computing device for use with embodiments of the invention.

FIG. 2 illustrates a block diagram of exemplary network environment for online backup storage.

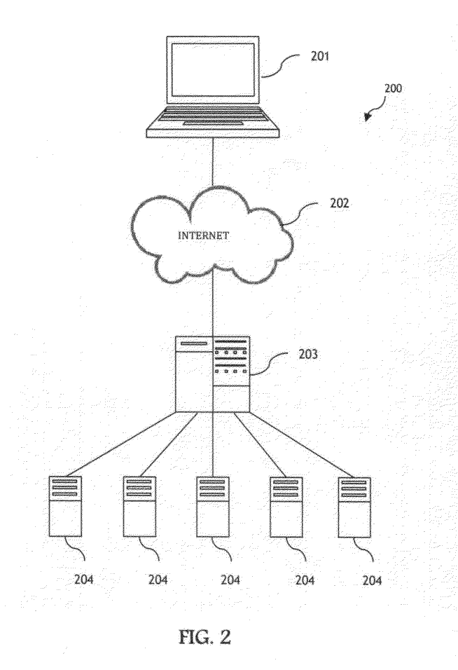

FIG. 3 illustrates the application User Interface presented to a user before accessing the remote backup server, in accordance with one embodiment of the invention.

FIG. 4 illustrates an exemplary application User Interface for displaying remotely backed up data in basic Windows desktop style User Interface, in accordance with one embodiment of the invention.

FIG. 5 illustrates the context menu displayed upon right clicking a folder icon on the application User Interface, in accordance with one embodiment of the invention.

FIG. 6 illustrates the context menu displayed upon right clicking a file icon on the application User Interface, in accordance with one embodiment of the invention.

FIG. 7 illustrates processing steps performed to access and display the remotely backup data by deploying Windows desktop style User Interface, in accordance with one embodiment of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

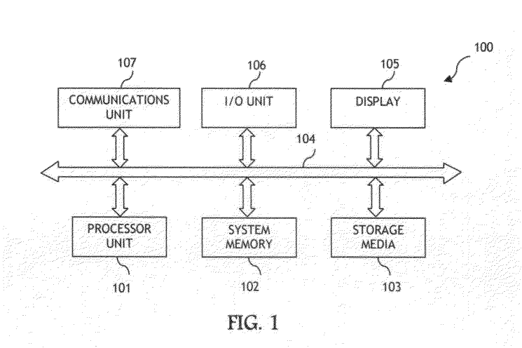

Referring now to FIG. 1 that illustrates an exemplary hardware and operating environment of a suitable computing device for use with embodiments of the invention. The figure represents a data processing system of a local computer which is preferably a fixed location computer, such as a desktop or a workstation etc, at workplace or home that a user accesses on regular basis. The local computer includes a local operating system (O/S) such as Windows operating System installed on it. The local computer further includes a network interface to communicate with a data server that provides a distributed file system to remote backup server.

In this illustrative example, Data Processing System 100 of the computing device includes Communications Fabric 104, provides communications between Processor Unit 101, System Memory 102, Storage Media 103, Communications Unit 107, I/O unit 106, and display 105 of the computing device. Processor Unit 101 serves to execute instructions for software that may be loaded into System Memory 102. Processor unit 101 may be a set of one or more processors or may be a multi-processor core, depending on the particular implementation. The Processing Unit 101 sends various data values, instructions, and information to all the devices and components inside Data Processing System 100 as well as different peripherals and devices attached.

The System Memory 102 is the place where the computing device holds current programs and data that are in use. The System Memory 102 can be divided into two essential types: RAM and ROM. RAM, or Random Access Memory is “volatile” which means that it only holds data while power is present. RAM changes constantly as the system operate, providing the storage for all data required by the operating system and software. ROM or Read Only Memory is always found on motherboards, but is increasingly found on graphics cards and some other expansion cards and peripherals. Instructions for the operating system, the object-oriented programming system, and applications or programs are located on Storage Media 103. These instructions may be loaded into System Memory 102 for execution by Processor Unit 101. The processes of the different embodiments may be performed by Processor Unit 101 using computer implemented instructions, which may be located in the System Memory 102. Similarly, in network environment, program modules depicted relative to Data Processing System 100, or portions thereof, may be stored in a Remote Memory Storage Device. Various modules and techniques may be described herein in general context of computer-executable instructions, such as program modules, executed by one or more computers or other devices. An implementation of these modules and techniques may be stored on or transmitted across some form of computer readable media. Storage Media 103 may include removable/non-removable, volatile/non-volatile computer storage media depending upon the particular implementation. For example, Storage Media 103 may be, a hard drive for reading from and writing to a non-removable, non-volatile magnetic media (not shown), magnetic disk drive for reading from and writing to removable, non-volatile magnetic disk (e.g. floppy disk) and optical disk drive for reading from and/or writing to a removable, non-volatile optical disk drive such as CD-ROM, DVD-ROM, a flash memory, or some combination of the above. The hard disk drive, magnetic disk drive and optical disk drive are each connected to the system bus through one or more data media interface.

Communications Unit 107, in these examples, provides media for communications with other data processing systems or devices. In these examples, Communications Unit 107 is a network interface card. I/O Unit 106 allows for input and output of data with other devices that may be connected to Data Processing System 100. For example, I/O Unit 106 may provide a connection for user input though a keyboard and mouse. Further, I/O Unit 106 may send output to a printer. Display 105 provides a mechanism to display information to a user. Data Processing System 100 can be connected to other remote computing devices via network connections constituting a computer network. Remote computing device for example can be a desktop or a server computer, laptops. Remote computing device may include many or all of the elements and features described herein relative to Data Processing System 100. Alternatively, Data Processing System 100 can operate in a non-networked environment as well. Networks connections between the Data Processing System 100 and remote computers may be a local area network (LAN) and a wide area network (WAN). A LAN covers a small geographic area, like a home, office, or building whereas a WAN covers a relatively broad geographic area (i.e. one city to another and one country to another country). In a LAN environment, Data Processing System 100 is connected to local network of computers via network adapter. When implemented in a WAN network environment, Data Processing System 100 includes modem or other means for establishing communications over network. Modem can be internal or external to computer; can be connected to system bus via I/O Unit 106 or other appropriate mechanisms. In some illustrative examples, the Data Processing System 100 may be a Personal Digital Assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A Communications Unit 107 may include one or more devices used to transmit and receive data, such as a modem or a network adapter. A memory may be, for example, main System Memory 102 or cache memory. A Processing Unit may include one or more processors or CPUs. The depicted examples in FIG. 1 and above-described examples are not meant to imply architectural limitations. The hardware in FIG. 1 may vary depending on the implementation. In addition, the processes of the illustrative embodiments may be applied to a multiprocessor data processing system.

Referring now to HG 2, that illustrates a block diagram of exemplary network environment for online backup storage. In one embodiment, a local computer 201 is connected to main storage server 203 through Internet 202. The main storage server 203 is further connected to a plurality of remote backup servers 204 that store the backed up data from local computer 201. Preferably, the system network 200 maintains continuous access to the Internet 202 through cable modem or DSL line. This allows the local computer 201 to continually have access to the data stored in the remote backup server 204. The local computer 201 may access the remote backup server 204 using any file sharing/transfer protocol known in the art. A remote backup server 204 is at a location remote from the local computer 201. The remote backup server 204 may be any computing device which is accessible to the user of the local computer 201 e.g. a remote backup server 204 may be a server belonging to third party service provider, other business location, a library, or another remotely located computer.

A user can remotely access the data stored in the remote backup servers 204 via main storage server 203 using the application User Interface provided by the application program. The application program running on a local computer 201 can access remote backup server 204 via the main storage server 203 by calling standard file management routines provided by the application program. The user may seamlessly access the same files from the same location as are stored in both the local computer 201 and the remote backup server 204.

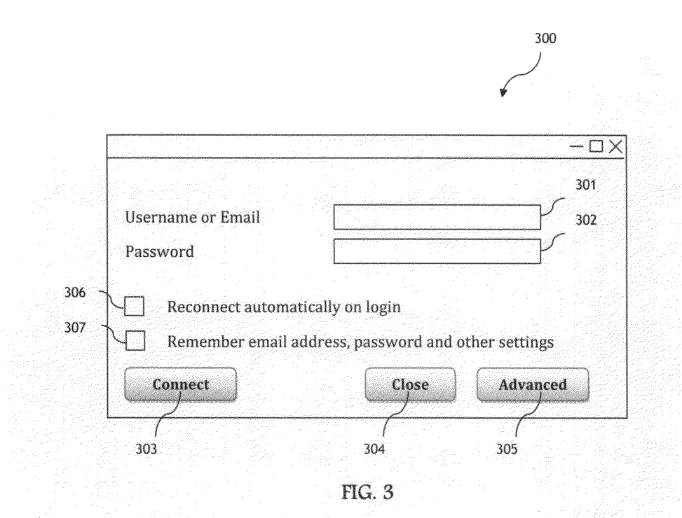

Referring now to FIG. 3 that illustrates the application User Interface presented to a user before accessing the remote backup server, in accordance with one embodiment of the invention. In preferred embodiments, the application program is installed on the local computer 201. Upon invoking the application program from the local computer 201, a User Interface 300 is presented that prompts the user to enter unique login information such as username and password provided for each user. After entering username or email ID in the name box 301, and password in the password box 302, the user may click the connect button 303 to log into the system. Upon clicking the connect button 303, the system establishes a connection with the remote backup server 204, via a secure line (such as encrypting data communication or using a Secure Socket Layer (SSL) protocol) and verifies the user. After user verification, the system provides access to remote backup server 204 and the hacked up data is displayed to the user in a manner similar to Windows desktop style User Interface. The desktop of application User Interface is identical to the desktop of windows operating system running on the local computer from where the backup was taken using the same login information.

In case the user doesn't want to login, he/she may click the close button 304 or may click advanced button 305 to explore further features provided on the application. The user may click the checkbox 306 in order to reconnect to the remote backup server 204 automatically upon login. Checkbox 307 may be marked in case the user wants the application to remember his/her login information such as username, password, email address or any other preferred settings.

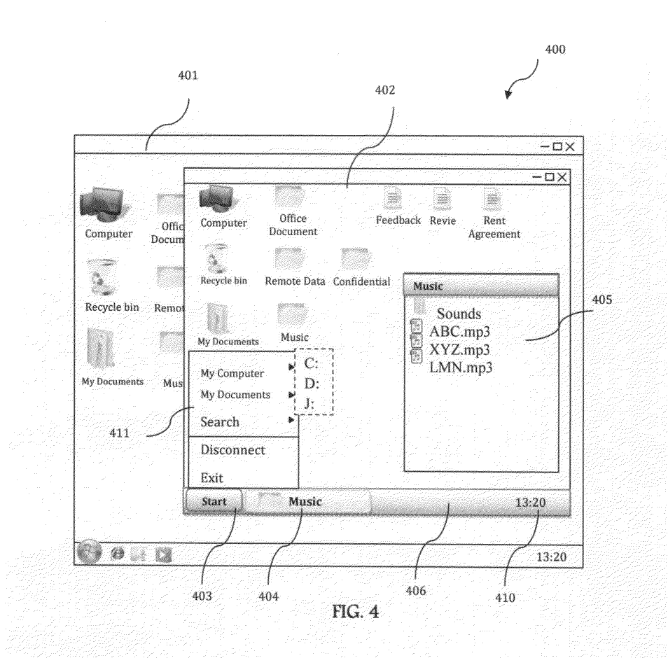

Referring now to FIG. 4 that illustrates an exemplary application User Interface for displaying remotely backed up data in basic Windows desktop style User Interface, in accordance with one embodiment of the invention. After an authorized user successfully logs into the application program through the User Interface as shown in the embodiment of FIG. 3, the application program running on the local computer 201 displays remotely stored data through a User Interface identical to the desktop of the windows operating system running on the local computer 201 from where backup was taken, thereby allowing a user to easily identify and access the data stored under various locations in remote backup server 204. The remote backup server 204 keeps a backup of all the data from the local computer 201 in the same manner as is stored in windows operating system. More specifically, the data is stored under the same folder names and same folder hierarchy including the icon names and positions of the icons on the windows desktop of the local computer 201. The application User Interface implements other functionalities of windows desktop such as taskbar, start menu button, etc. Since the User Interface of the application program is similar to the User Interface provided by the Windows Operating system, the user is easily able to visually recognize the same file system from the remote backup server 204 as is available on the local computer 201.

In preferred embodiments, user settings for the User Interface can also be maintained by the remote backup server 402. When a user logs into the application program after authentication, the last saved user settings are generated and displayed on the application User Interface. Each time a user terminates the application program session; last saved user settings are automatically saved and generated and applied next time the user log into the application program. The desktop icons are automatically placed in the same position as were arranged before termination of the previous session. In this way, the user automatically returns to the exact desktop environment in the state at the time of the prior access. More precisely, the application User Interface provided by the application program is an exact replica of the desktop of the Windows Operating System of the local computer from where the backup was taken.

According to one embodiment of the invention, the User Interface displayed under a particular login name is identical to the User Interface of the local computer 201 from where backed up under the same login name. For example, if a user takes a backup from a local computer 201, the User Interface displayed to him will be same as the User Interface of the Windows Operating System as was generated during his last backup activity. If the same user logs in from another local computer using the same login information, he will be presented with the User Interface of Windows Operating System from where the backup was taken.

According to one more embodiment of the invention, a major portion the application User Interface 402 displays a plurality of elements such as files/folders icons etc. which are arranged in the same manner as are arranged in the local computer 201 from where the backup was taken. The icons in the form of file/folders represent a shortcut to the data stored under various locations and under the same filename as stored in the remote backup server. Upon double clicking any of these folder icons such as ‘My Documents’, ‘Office Document’, ‘Remote Data’, ‘Music’ etc. with left mouse button, another window pops up which is named as the clicked folder name e.g. upon clicking the ‘Music’ folder, a window 405 entitled ‘Music’ is popped up which lists each backed up files/folders stored inside it. The name of the folder window which is open is presented as a button 404 on the taskbar 406. Thus, the user is provided with a visual cue that a window, that is associated with the task, is currently active. The icons on the application User Interface 402 provide a user with a clear and integral indication of the data stored in the remote backup server 204. The application User Interface 402 also directly displays files such as text files or any other file format directly stored under top level in the remote backup server 204. Remote backup server 204 maintains a set of image icons for representing the stored data according to file and creator type information. Remote backup server 204 selects and displays an appropriate icon as a function of the file and creator information stored within virtual storage area. While accessing, the user can access the folders and files within the remote storage seamlessly. The system also provides user with an option to restore data to the local computer 201. Folder controls may be activated in any conventional graphical User Interface manner (e.g. ‘clicking on it’). Activation of folder control functions to bring to a top level of User Interface folders (i.e. folder icons) representing, for example, folders or sub folders in a network space. In this embodiment, the user interacts with the User Interface presented by the system and facilitates intuitive and user friendly management of remote storage data in a manner similar to a local storage volume.

According to another embodiment of the invention, a taskbar 406 is provided on the bottommost portion of the application User Interface 402 that includes a plurality of user selectable buttons to initiate a variety of operations. Taskbar 406 is a consistently visible User Interface element that informs a user which tasks are currently active. It serves as a point for displaying currently active task windows. A button is displayed for each active task. Just like Windows Operating system, a user merely need to single click on the button in order to switch to an active task.

According to yet another embodiment of the invention, the left most portion of the taskbar 406 includes a ‘Start’ button 403 which serves as a centralized location for accessing data stored under various locations. Upon left mouse click on the ‘Start’ button 403, a popup menu 411 with options such as ‘My Computer’, ‘My Documents’, ‘Search’, ‘Disconnect’ and ‘Exit’ is displayed in the same manner as a desktop is displayed on a local computer running Windows Operating System. All these icons further display their sub menus or next level of data upon clicking them. The search menu provides for searching a particular file or folder on the remote backup server 204. Upon left mouse click on ‘My Computer’ button, various disk drives (C:, D: or E:) of the remote backup server 204 are displayed in the same manner as in a local disk drive in a Windows operating system. Upon left mouse click on ‘My documents’ button, a list of last opened files on the remote backup server 204 are displayed as a popup menu. Upon left mouse click on ‘Search’ button, a search window is displayed that assists in searching for a file or folder through backed up data on remote backup server 204. Upon left mouse click on ‘Disconnect’ button, the user can disconnect the local computer 201 from the remote backup server 204. Upon left mouse click on ‘Exit’ button, the user can close down the application program and exit. The width of each button on the taskbar varies depending upon number of active tasks and the amount of space available on the taskbar 406. The rightmost portion of the taskbar includes a clock which displays a digital clock 420.

In one embodiment, once the data has been stored in remote backup server 204, a user can easily perform common drag and drop operations on file/folder icons on the application User Interface 402 whereby a file or a folder from remote backup server 204 can be easily dragged and dropped to a desired location on the local computer 201 in order to restore the data. To upload a data to the remote backup server 204, user can again drag the file/folder icon from the local computer 201 and drop it at a desired location on the remote backup server 204.

Using the User Interface as represented by application User Interface 402, a user can perform many common file management operations including uploading, downloading, and other related functions in a manner similar to windows operating system. The User Interface provided by the system displays remotely stored data in a user friendly and familiar manner and provides a seamless access to remote backup server 204. The Window desktop style User Interface allows a user to intuitively access the file monitoring application features.

It will be appreciated that data files, folders and shortcuts are represented or designated in the form of icons that are basically pictograms used in graphical User Interfaces to supplement the presentation of a file, folder, application or device on a computer operating system. These are merely the virtual representation of the data residing in the server.

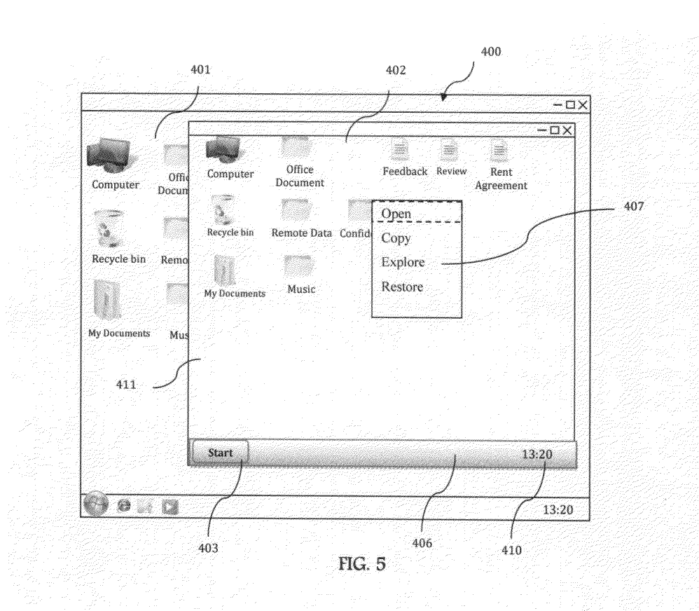

Referring now to FIG. 5 that illustrates the context menu displayed upon right clicking a folder icon on the application User Interface, in accordance with one embodiment of the invention. When a user right clicks the mouse button on one of the folder icons on the Application User Interface 402, a folder context menu 407 is displayed next to the file/folder which allows a user to select an action out of various options provided in context of a folder that may include actions such as open, copy, explore, restore etc. whereby a folder can be opened, copied, explored through windows browser or restored to its original location on the local computer 201 from where it was uploaded during backup.

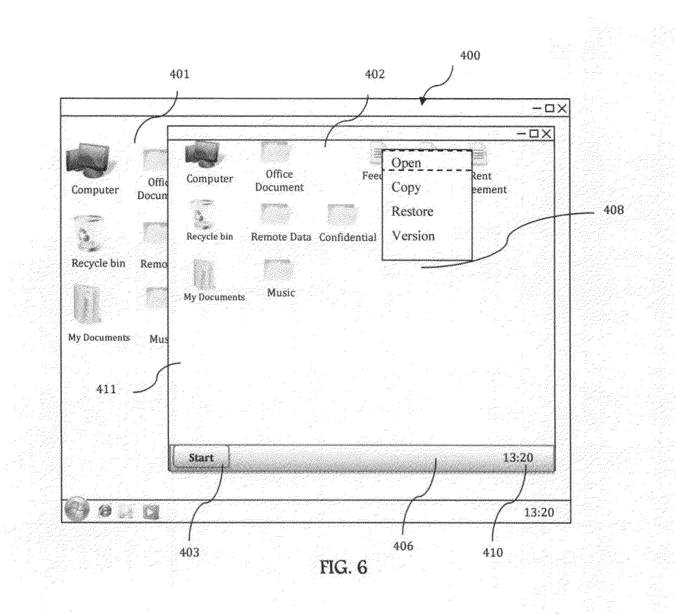

Referring now to FIG. 6 that illustrates the context menu displayed upon right clicking a file icon on the application User Interface, in accordance with one embodiment of the invention. When a user right clicks the mouse button on one of the file icons on the application User Interface 402, a file context menu 407 is displayed next to the file which allows a user to select an action out of various options provided in context of a file that may include operations such as open, copy, restore, version etc. whereby a file can be opened, copied, restored to its original location on the local computer 201 or its version information can be viewed by the user. The context menu provides options for easy and seamless management of data on the remote backup server 204.

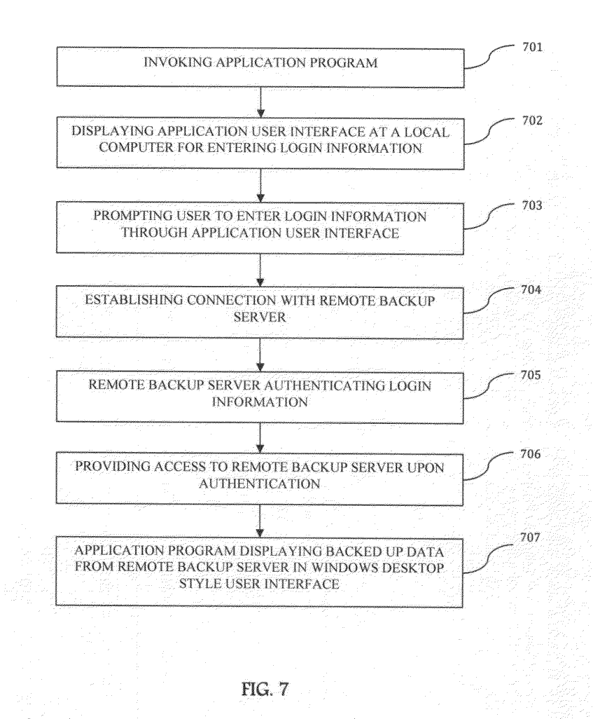

Referring now to FIG. 7 that illustrates processing steps performed to access and display the remotely backup data by deploying Windows desktop style User Interface, in accordance with one embodiment of the invention. In operation 701, the user invokes the installed application program by double clicking the program icon on the program menu or shortcut on the desktop of the windows operating system running on the local computer 201. At operation 702, an application User Interface 402 is displayed that prompts the user to enter his unique login information such as username and password (as explained with respect to FIG. 3 above) in order to access the remote backup server 209. At operation 703, the user enters the login information prompted by the application program. At operation 704, the application program establishes a connection with remote backup server 204 via a secure line (such as encrypting data communication or using a Secure Socket Layer (SSL) protocol). At operation 705, the remote backup server 204 performs user authentication based on the login information entered by the user. At operation 706, upon authentication, the method provides access to remote backup server 204 and displays the backed up data in a format identical to the User Interface of the windows desktop of the local computer 201 from where the backup was taken under the same login information.

In specific embodiments, any distributed file system may be utilized that provides secure and authenticated access and which is accessible from remote computers via internet or a network. The main storage server 203 and remote backup server 204 are shown as separate that however, may be implemented in the same server machine including the network file system.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for accessing and displaying remotely backed up data by deploying a windows desktop style User Interface, said system comprising:
a. at least one local computer running windows operating system;
b. at least one remote backup server connected to the local computer through a communication means wherein the remote backup server is having backup of data from at least one of the local computer;
c. an application program installed on the local computer.

2. The system as in claim 1 wherein communication means between the local computer and the remote backup server may be effected by way of Internet and a remote secure access network connectivity.

3. The system as in claim 1 wherein the remote backup server is any computing device having capabilities for data storage and capabilities to connect to the local computer by way of communication means.

4. The system as in claim 1 wherein the remote backup server is connected to local computer after authentication wherein the authentication further comprises remote backup server verifying both the user name and password entered by the user through application User Interface whereby a user is authenticated before allowing access to the remote backup storage.

5. The system as in claim 1 wherein the data from the local computer is stored in the remote backup server under the same folder names and identical file system hierarchy.

6. The system as in claim 1 wherein the application User Interface displayed to the user while accessing remotely backed up data through said application program is similar to the desktop of the Windows operating system running on the local computer whereby the user can seamlessly access the same files from the same location as are stored in both the local computer and the remote backup server, through an identical User Interface.

7. The system as in claim 5 wherein a major portion of the application User interface displays a plurality of icons representing files or folders wherein names, positions and arrangement of the icons are similar to the ones on desktop of Windows operating system of the local computer from where the backup was taken.

8. The system as in claim 7 wherein each of said icons on application User interface represents a shortcut to the data stored under various locations of the remote backup server.

9. The system as in claim 7 wherein upon right mouse click on a folder icon on application User Interface, a context menu is popped up next to the folder icon which allows a user to select an action out of a plurality of options provided in context of a folder that includes actions such as open, copy, explore, restore whereby folder can be opened, copied, explored through windows browser or restored to its original location on the local computer from where it was uploaded during backup.

10. The system as in claim 7 wherein upon right mouse click on a file icon on application User Interface, a context menu is popped up next to the file icon which allows a user to select an action out of various options provided in context of a folder that includes actions such as, open, copy, restore, version whereby a file can be opened, copied, restored to its original location on the local computer or its version information can be viewed by the user.

11. The system as in claim 5 wherein a consistently visible taskbar is provided at the bottom most portion of the application User Interface that further comprises a plurality of user detectable button to initiate a variety of operations.

12. The system as in claim 11 wherein said taskbar displays, in the form of button, currently active task running on the application User Interface.

13. The system as in claim 11 wherein the left most portion of the taskbar further comprises a ‘Start’ button that serves as a centralized location for accessing data stored under various locations on remote backup server whereby a user can click and readily get access to various location on remote backup server.

14. The system as in claim 13 wherein upon left mouse click on ‘Start’ button’, a popup menu, with options such as ‘My Computer’, ‘My Documents’, ‘Search’, ‘exit’, is displayed wherein:
upon left mouse click on ‘My Computer’ button, various disk drives (C:, D: or E:) of the remote backup server are displayed as a popup menu;
upon left mouse click on ‘My documents’ button, a list of last opened files on the remote backup server are displayed as a popup menu;
upon left mouse click on ‘Search’ button, a search windows is displayed that assists in searching for a file or folder through backed up data on remote backup server;
upon left mouse click on ‘Disconnect’ button, the user can disconnect the local computer from the remote backup server;
upon left mouse click on ‘Exit’ button, the user can close down the application program and exit.

15. The system as in claim 1 wherein through application User Interface, upload or download of data between remote backup server and local computer can be performed by easy operation of drag and drop whereby a user can easily exchange data between local computer and remote backup server.

16. The system as in claim 1 wherein each time a user terminates the application program, user settings for the application User Interface are automatically saved.

17. The system as in claim 16 wherein last saved user settings are generated and applied next tome the user logs into the application program whereby desktop icons are automatically placed in the same positions as were arranged before termination of the previous session and the user automatically returns to the exact desktop environment in the state at the time of the prior access.

18. In a computer system having an input device, a video display, and applications for running on the system, a method for accessing remotely backed up data by deploying a windows desktop style User Interface, the method comprising the steps of:
a. displaying application User Interface at a local computer for entering login information;
b. prompting user to enter login information through application User Interface;
a. establishing a connection with the remote backup server through communication means by way of Internet and a remote secure access network connectivity;
b. remote backup server authenticating the login information;
c. providing access to remote backup server upon authentication;
d. application program displaying the backed up data from remote backup server in windows desktop style User Interface.

19. The method as in claim 18 wherein said application User Interface is displayed by the application program installed on the hard disk drive running a Windows operating system.

20. The method as in claim 18 wherein login information comprises a set of User name and password assigned to a user at the time of taking backup on remote backup storage.

21. The method as in claim 18 wherein the step of authentication further comprises remote backup server verifying both the user name and password by way of the communication means whereby a user is authenticated before allowing access to the remote backup storage.

22. The method as in claim 18 wherein the data from the local computer is stored in the remote backup server under the same folder names and identical file system hierarchy.

23. The method as in claim 18 wherein the application User Interface displayed to the user while accessing remotely backed up data through said application program is similar to the desktop of the Windows operating system running on the local computer whereby the user can seamlessly access the same files from the same location as are stored in both the local computer and the remote backup server, through an identical User Interface.

24. The method as in claim 23 wherein a major portion of the application User interface displays a plurality of icons representing files or folders wherein names, positions and arrangement of the icons are similar to the ones on desktop of Windows operating system of the local computer from where the backup was taken.

25. The method as in claim 24 wherein each of said icons on application User interface represents a shortcut to the data stored under various locations of the remote backup server.

26. The method as in claim 24 wherein upon right mouse click on a folder icon on application User Interface, a context menu is popped up next to the folder icon which allows a user to select an action out of a plurality of options provided in context of a folder that includes actions such as open, copy, explore, restore whereby folder can be opened, copied, explored through windows browser or restored to its original location on the local computer from where it was uploaded during backup.

27. The method as in claim 24 wherein upon right mouse click on a file icon on application User Interface, a context menu is popped up next to the file icon which allows a user to select an action out of various options provided in context of a folder that includes actions such as open, copy, restore, version whereby a file can be opened, copied, restored to its original location on the local computer or its version information can be viewed by the user.

28. The method as in claim 23 wherein a consistently visible taskbar is provided at the bottom most portion of the application User Interface that further comprises a plurality of user detectable button to initiate a variety of operations.

29. The method as in claim 28 wherein said taskbar displays, in the form of button, currently active task running on the application User Interface.

30. The method as in claim 28 wherein the left most portion of the taskbar further comprises a ‘Start’ button that serves as a centralized location for accessing data stored under various locations on remote backup server whereby a user can click and readily get access to various location on remote backup server.

31. The method as in claim 30 wherein upon left mouse click on ‘Start’ button’ a popup menu, with options such as ‘My Computer’, ‘My Documents’, ‘Search’, ‘exit’, is displayed wherein:
upon left mouse click on ‘My Computer’ button, various storage locations (C:, D: or E:) of the remote backup server are displayed as a popup menu;
upon left mouse click on ‘My documents’ button, a list of last opened files on the remote backup server are displayed as a popup menu;
upon left mouse click on ‘Search’ button, a search windows is displayed that assists in searching for a file or folder through backed up data on remote backup server;
upon left mouse click on ‘Disconnect’ button, the user can disconnect the local computer from the remote backup server;
upon left mouse click on ‘Exit’ button, the user can close down the application program and exit.

32. The method as in claim 18 wherein through application User Interface, upload or download of data between remote backup server and local computer can be performed by easy operation of drag and drop whereby a user can easily exchange data between local computer and remote backup server.

33. The method as in claim 18 wherein each time a user terminates the application program, user settings for the application User Interface are automatically saved.

34. The method as in claim 33 wherein last saved user settings are generated and applied next tome the user logs into the application program whereby desktop icons are automatically placed in the same positions as were arranged before termination of the previous session and the user automatically returns to the exact desktop environment in the state at the time of the prior access.
